(19) United States
(12) Patent Application Publication
(10) Pub. No.: US 2021/0319922 A1
(43) Pub. Date: Oct. 14, 2021

(54) Electric Heating for Nuclear Reactors

(71) Applicant: Bob Burkett, Carrollton, TX (US)

(72) Inventor: Bob Burkett, Carrollton, TX (US)

(73) Assignee: Bob Burkett, Carrollton, TX (US)

(21) Appl. No.: 17/222,976

(22) Filed: Apr. 5, 2021

Related U.S. Application Data
(60) Provisional application No. 63/009,453, filed on Apr. 13, 2020.

(51) Int. Cl. G21C 19/08

(52) U.S. Cl. CPC G21C 19/08

(57) ABSTRACT

Electric Heating for Nuclear Reactors is a system and method for the replacement of nuclear fuel rods within the core of a nuclear reactor with submersible (immersion) electric heaters.

### CROSS-REFERENCE TO RELATED APPLICATIONS

This application claims the benefit of the filing of U.S. Provisional Patent Application No. 63/009,453 filed on Apr. 13, 2020.

### BACKGROUND OF THE INVENTION

The generation of electricity is fundamental to modern society. The current primary means involve nuclear fission, fossil fuel heated boilers, solar power and wind turbines. Also, gas turbines and steam turbines are utilized for Combined and Simple Cycle power plants. However, nuclear power has numerous problems. Chernobyl, Three Mile Island and Fukushima are examples of the negative consequences of nuclear power. There is not an acceptable means for the disposal of radioactive waste. Yucca Mountain (a potential repository for nuclear waste) is in an undetermined state. On the shores of the Great Lakes in the United States is a repository with 60,000 tons of nuclear waste which is an accident waiting to happen. In addition, the majority of nuclear waste is stored next to the power plant where it is produced.

Currently, the Shoreham Nuclear Power Plant is shut down in New York. The San Onofre Nuclear Generator (SONG) in California is closed due to safety concerns and is being decommissioned. The Diablo Canyon Nuclear Power Plant in California is scheduled to be shut down in 2024 and 2025 due to safety concerns after the Fukushima disaster. The estimated cost to decommission the power plant is 4 billion dollars. There were 43 nuclear reactors in Japan that were shut down in 2017 after the tsunami. There are currently approximately 100 operational nuclear plants in the United States. The problem that exists is that nuclear power is potentially very dangerous and the waste product is highly radioactive. The inherent dangers of nuclear power include uncontrolled radioactivity, radioactive waste and potential explosions.

### BRIEF SUMMARY OF THE INVENTION

The purpose of this Application is to reduce and/or remove the need for nuclear power for the purpose of electricity production from grid scale power plants and any other current uses that require nuclear fission. In order to solve this problem new uses and improvements of existing technologies are necessary.

Inside a nuclear reactor, fuel rods that contain uranium pellets are bundled together to form a fuel assembly within the reactor vessel. The fuel assemblies are loaded into the reactor core. These assemblies would be removed and replaced by submersible (immersion) electric heaters. There are a variety of different types of immersion heaters including flange, screw plug and other types. The submersible (immersion) electric heaters in this embodiment will require a large amount of electricity to operate. A terrestrial based power plant already uses part of the electricity they generate for the grid to operate the plant infrastructure; the electric heaters will be another load on the system. This system and method can also be used for new power plant construction. In the rapidly developing countries of China and India this could be a positive game changer. This system and method could also be used in Japan in order to remove the future threat of additional nuclear disasters. The concept can be utilized on nuclear power plants around the world.

The benefits of this process include the reduction of the cost of exploration, processing and transportation of uranium. This system and method reduce the inherent dangers of nuclear power including uncontrolled radioactivity, radioactive waste and potential explosions. The system and method reduce the continual refueling expense of uranium for the power plant operator. The concept would also reduce the need for the decommissioning of current nuclear power plants which would save billions of dollars and thousands of jobs. This system and method would also allow the owner of the power plant to continue to generate electricity. The net result would be fossil fuel free grid scale electricity.

Alternative embodiments would include the utilization of this Application's system and methods for propulsion and electricity production for ships, submarines and other marine vessels.

### BRIEF DESCRIPTION OF THE SEVERAL VIEWS OF THE DRAWINGS

FIG. 1 is a top-down view of a nuclear reactor vessel (100) with fuel assemblies (101). The number 100 represents the reactor vessel. In this view the number 101 is representative of all of the small squares representing fuel assemblies. A large number of fuel rods are bundled together to create a fuel assembly.

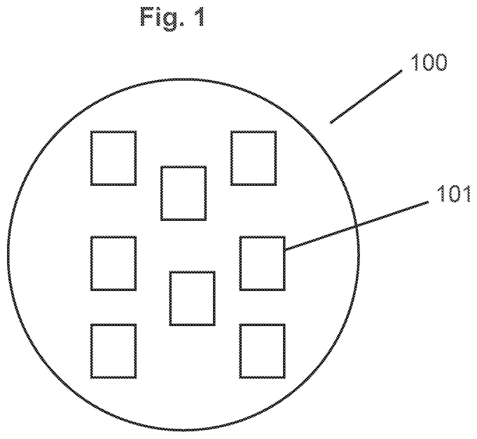

FIG. 2 is a side view of a nuclear reactor vessel (200) with nuclear fuel assemblies (201), The number 200 represents the reactor vessel. In this view the number 201 is representative of all of the thin rectangles representing fuel assemblies (201). A large number (50-300) of fuel assemblies (201) are placed within the reactor vessel (200) for the fission process. The fuel assemblies are placed within the reactor core.

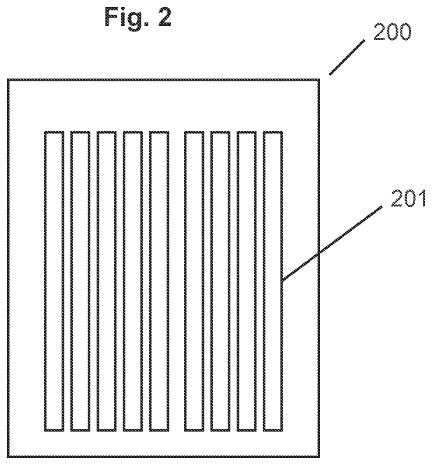

FIG. 3 is a top-down view of a fuel assembly (300). In this figure the fuel assembly (300) contains numerous bundles of fuel rods (301) that contain uranium or any other fissile material. The number 301 is representative of all the fuel rods depicted by circles in the figure.

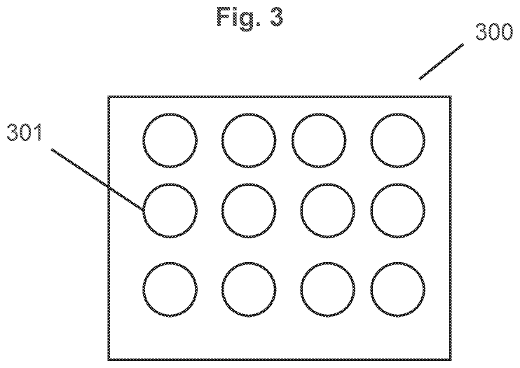

FIG. 4 is a side view of a fuel assembly (400). The fuel assembly (400) contains fuel rods (401). The number 401 is representative of all of the long rectangles within the fuel assembly (400).

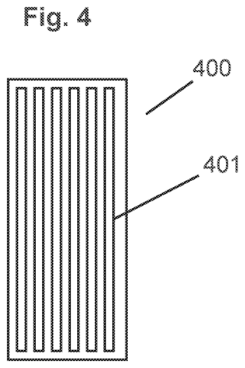

### DETAILED DESCRIPTION OF THE INVENTION

A nuclear reactor vessel (100, 200) contains fuel rods (301, 401) filled with uranium pellets that heat water during the fission process. A large number of fuel rods (301, 401) are bundled together to create a fuel assembly (101, 201, 300, 400). Inside the reactor, fuel rods that contain uranium pellets are bundled together to form a fuel assembly within the reactor vessel. The fuel assemblies are loaded into the reactor core. These assemblies would be removed and replaced by submersible (immersion) electric heaters. These rods (and assemblies) would be removed and replaced with submersible (immersion) electric heaters (not shown) that reach the same or greater temperature as the nuclear fuel rods during the fission process. This would result in the water temperature reaching the same temperature as a nuclear reactor.

According to the Union of Concerned Scientists the temperature inside a nuclear reactor is approximately 500 degrees Fahrenheit. According to Pacific Gas and Electric (PG&E) the water temperature reaches 600 degrees Fahrenheit. A variety of different types of electric immersion heaters already exist at the time of this writing that can reach up to 1600 degrees Fahrenheit by a variety of manufacturers. An example are the heaters manufactured by Watlow. They include Alloy 800 with a maximum temperature of 1600° F. or 870° C., Stainless Steel with a maximum temperature of 1200° F. or 650° C. and Steel with a maximum temperature of 750° F. or 400° C. Another example of potential manufacturers is Omega Engineering.

Nuclear power plants already create electricity with the use of a generator for internal operations and the power grid, the powering of the electric heaters would be another load on the system. The electric heaters could also be powered by the external grid, backup generators, and emergency generators. This solution would remove the danger of nuclear power while retaining the benefits of fossil fuel free electricity on a grid scale system.

### LIST OF REFERENCE NUMERALS

100. Reactor Vessel
101. Fuel Assembly
200. Reactor Vessel
201. Fuel Assembly
300. Fuel Assembly
301. Fuel Rod
400. Fuel Assembly
401. Fuel Rod

1. A system to heat water in a nuclear reactor, the system comprising:
the nuclear reactor;
immersion electric heaters;
and whereby the immersion electric heaters heat the water.

2. The system according to claim 1, wherein nuclear fuel rods are replaced with immersion electric heaters.

3. The system according to claim 1, wherein the immersion electric heaters are comprised of Alloy 800 with a maximum temperature of 1600° F. or 870° C. and/or Stainless Steel with a maximum temperature of 1200° F. or 650° C. and/or Steel with a maximum temperature of 750° F. or 400° C.

4. The system according to claim 1, wherein the immersion electric heaters are powered by a power plant generator.

5. The system according to claim 1, wherein the immersion electric heaters are powered by an external electricity grid.

6. The system according to claim 1, wherein the immersion electric heaters are powered by a backup generator and/or an emergency generator.

7. The system according to claim 1, wherein propulsion and electricity production for ships, submarines and other marine vessels is generated.

8. The system according to claim 1, wherein the system is utilized for new power plant construction.

9. A method of heating water in a nuclear reactor comprising:
providing the nuclear reactor;
utilizing submersible and/or immersion electric heaters to heat the water.

10. The method of claim 9 further comprising replacing nuclear fuel rods with submersible electric heaters.

11. The method of claim 9 further comprising replacing nuclear fuel rods with immersion electric heaters.

12. The method of claim 9 further comprising using a power plant generator to power the submersible and/or immersion electric heaters.

13. The method of claim 9 further comprising using an external electricity grid to power the submersible and/or immersion electric heaters.

14. The method of claim 9 further comprising using a backup generator and/or an emergency generator to power the submersible and/or immersion electric heaters.

15. The method of claim 9 further comprising propulsion and electricity production for ships, submarines and other marine vessels.

16. The method of claim 9 further comprising utilizing the method for new power plant construction.

17. A system to heat water in a nuclear reactor, the system comprising:
the nuclear reactor;
submersible electric heaters;
and whereby the submersible electric heaters heat the water.

18. The system according to claim 17 wherein the submersible electric heaters are powered by a power plant generator.

19. The system according to claim 17, wherein nuclear fuel rods are replaced with submersible electric heaters.

20. The system according to claim 17, wherein the system is utilized for new power plant construction.
